(19) United States
(12) Patent Application Publication
(10) Pub. No.: US 2014/0127535 A1
(43) Pub. Date: May 8, 2014

(54) ENERGY STORAGE ARRANGEMENT AND ENERGY STORAGE APPARATUS

(71) Applicants: Tim Schaefer, Harztor (DE); Jens Meintschel, Bernsdorf (DE)

(72) Inventors: Tim Schaefer, Harztor (DE); Jens Meintschel, Bernsdorf (DE)

(73) Assignee: LI-TEC BATTERY GMBH, Kamenz (DE)

(21) Appl. No.: 14/009,938

(22) PCT Filed: Mar. 30, 2012
(86) PCT No.: PCT/EP2012/001434

§ 371 Date: Jan. 17, 2014

(30) Foreign Application Priority Data
Apr. 4, 2011 (DE) 10 2011 016 017.4

(51) Int. Cl. H01M 2/20

(52) U.S. Cl. CPC H01M 2/202; H01M 2/204; H01M 2/206
USPC 429/50; 429/121

(57) ABSTRACT

The invention relates to an energy storage arrangement (5), comprising a plurality of partial energy stores (1) and a contacting device (6) for contacting several partial energy stores (1) to one another. Each partial energy store (1) has a frame structure (2) supporting an energy storage section (4) having an electrode array and at least two connecting ends. The partial energy store is provided with a pressure segment (2.2) and a contact segment (3), wherein the connecting ends of the energy storage section (4) are connected to the contact segment (3). The pressure segment (2.2) is configured and arranged to elastically push the contacting device (6) against the contact segment (3). The invention further relates to an energy storage device (1), which is in particular well suited for partial energy stores (1) in an energy storage arrangement (5) such as described above.

The entire content of the DE 10 2011 016 017 priority application is fully incorporated as an integral part of the present application by reference herein.

The present invention relates to an energy storage arrangement and an energy storage apparatus.

Stacking and interconnecting a plurality of electrical energy storage cells or battery cells respectively, such as for instance lithium ion-based flat cells, into batteries is known. The assembly of such batteries is often laborious. It is also often not possible to exchange individual components (cells or partial modules) without disassembling the entire battery. Particularly after a battery cell fails, some known battery designs make it necessary to at least intermittently interrupt the supply of a load in order to replace a battery cell.

It is an object of the present invention to improve the supplying of a connected load, particularly in the event of a battery cell failure.

This object is accomplished by the features of the independent claims. Advantageous further developments of the invention constitute the subject matter of the subclaims.

One aspect of the invention proposes an energy storage arrangement comprising a plurality of partial energy stores as well as a contacting device for interconnecting a plurality of partial energy stores. Each partial energy store comprises a frame structure which supports an energy storage section having an electrode array and at least two connecting ends. The partial energy store has a pressure section and a contact section. The connecting ends of the energy storage section are connected to the contact section. The pressure section is designed and arranged so as to elastically push the contacting device against the contact section.

In the terms of the invention, an energy storage arrangement is to be understood particularly as an arrangement which is provided to absorb, store and in turn release particularly electrical energy, preferably by converting electrical energy into chemical energy and vice versa.

In the terms of the invention, a partial energy store is to be understood particularly as a self-contained functional unit of the energy storage arrangement which in itself is provided to absorb, store and in turn release particularly electrical energy, preferably by converting electrical energy into chemical energy or vice versa.

A storage cell in the sense of the invention refers particularly to a galvanic primary or secondary cell (in the context of the present application, primary or secondary cells are indiscriminately referred to as battery cells and an energy storage apparatus composed therefrom as a battery). A fuel cell, a high-performance capacitor such as for instance a supercap or the like or different types of energy storage cells are also to be understood as storage cells in the sense of the invention. Particularly a storage cell composed of battery cells comprises an active section or active part in which the conversion of electrical energy into chemical energy or vice versa occurs, a casing to encapsulate the active part from the environment and at least two electrical terminals. The active part comprises in particular an electrode array configured preferably as an electrode stack, a substantially cylindrical electrode coil or a flat wound. The electrode array is formed with collector films, active layers and separator layers. The active layers are provided as coatings of the collector films. The terminals are electrically connected to or formed integrally with the collector films.

According to the invention, the pressure section formed in the partial energy store is designed and arranged to elastically push the contacting device against the contact section of the partial energy store. Particularly assembly of the partial energy store in the energy storage arrangement is advantageously facilitated. Further advantageous is reliably ensuring the interconnecting of the partial energy stores. In the terms of the invention, pushing the contacting device against the contact section of the partial energy store can thereby also be understood as pushing the contact section of the partial energy store against the contacting device. Preferably the pressure section of a partial energy store is braced against its contact section, particularly when the partial energy store is inserted into the energy storage arrangement.

With the inventive design of a partial energy store having a pressure section and a contact section, the partial energy store can be withdrawn from or inserted into the energy storage arrangement independently of neighboring partial energy stores. By the pressure section pushing the contacting device toward the contact section, particularly defective partial energy stores can be removed while the energy storage arrangement is in operation. A partial energy storage can further be inserted into the energy storage arrangement during operation. With the inventive design of the partial energy store, it is therefore not necessary to interrupt the supplying of a load to replace a partial energy store. The underlying objective is thereby accomplished.

Preferably, the energy storage arrangement is configured such that the contacting device comprises at least two conductor rails. A conductor rail in the sense of the invention is to be understood as a substantially continuous, particularly electrically conductive component. At least two conductor rails of the contacting device are electrically insulated from one another.

Preferably, the pressure section is elastically movable by a spring section of the frame structure. Advantageously, the pressing together of the contacting device and the contact section of the partial energy store is realized by an intrinsic property of the partial energy store or its frame structure respectively without any further elements. The material of the spring section is preferably designed to enable a flexible and deformable spring section. A restoring force from the deformation of the spring section advantageously results in a conductor rail of the contacting device being clasped particularly in force-locking manner by the pressure section and contact section in the installed state of a partial energy store. An electrical contact between the contact section and an electrically conductive conductor rail is further advantageously effected.

Preferably, the frame structure comprises a receiving section for receiving a section of the contacting device allocated to the partial energy store. Changing of a partial energy storage during the supplying of a load is advantageously facilitated. Preferably an encapsulated, thus not readily accessible externally, guiding of the contacting device can also be realized. The contacting device can furthermore also be contacted within the partial energy storage.

Preferably the receiving section is open on one side. The inserting and disconnecting of partial energy stores is advantageously facilitated, particularly during the supplying of a load.

Preferably, the receiving section comprises at least one engaging section to engage the contacting device. An unintentional disengaging of a partial energy store is advantageously hindered.

In accordance with a further aspect of the invention, an energy storage apparatus having a frame structure which supports an energy storage section comprising an electrode array and at least two connecting ends is also proposed, wherein the frame structure comprises a receiving section to receive at least one section of a contacting device for interconnecting a plurality of energy storage apparatus together, wherein the energy storage apparatus comprises a pressure section and a contact section, wherein the connecting ends of the energy storage section are connected to the contact section and wherein the pressure section is designed and arranged to elastically push the contacting device against the contact section.

The energy storage apparatus can be a partial energy store in the sense of the previous aspect of the invention.

In further configurations of the invention, the energy storage section is either integrated into the frame structure of the energy storage apparatus or detachably connected to the frame structure, particularly engageable with same.

An inventive energy storage arrangement, an inventive energy storage cell and an inventive heat-conducting element are provided particularly for use in a motor vehicle, whereby the motor vehicle is in particular a hybrid vehicle or an electric vehicle.

The invention is in particular, but not solely, applicable to energy stores having an array of electrodes comprising lithium or a lithium compound as an electrochemically active component.

The preceding and further features, functions and advantages of the present invention will become considerably clearer from the following description which makes reference to the accompanying figures.

### BRIEF DESCRIPTION OF THE FIGURES

FIG. 1 shows a schematic spatial view of a single battery;

FIG. 2 shows a schematic cross-sectional view of an internal structure of the single battery from FIG. 1;

FIG. 3 is a schematic sectional view of the single battery along dashed/dotted line III-Ill from FIG. 2 in the viewing direction of the associated arrows;

FIG. 4 shows a schematic spatial view of a battery assembly having a plurality of single batteries; and

FIG. 5 shows a schematic spatial view of a battery case with a controller and a plurality of conductor rails.

It is to be noted that the figure illustrations are schematic and are at least substantially limited to depicting the features helpful in understanding the invention. It is also to be noted that the dimensions and scale ratios shown in the figures are essentially as such for the purpose of providing clarity to the depictions and are not necessarily to be understood as limiting unless noted otherwise in the description.

The same reference numerals are provided in all the figures to mutually corresponding components.

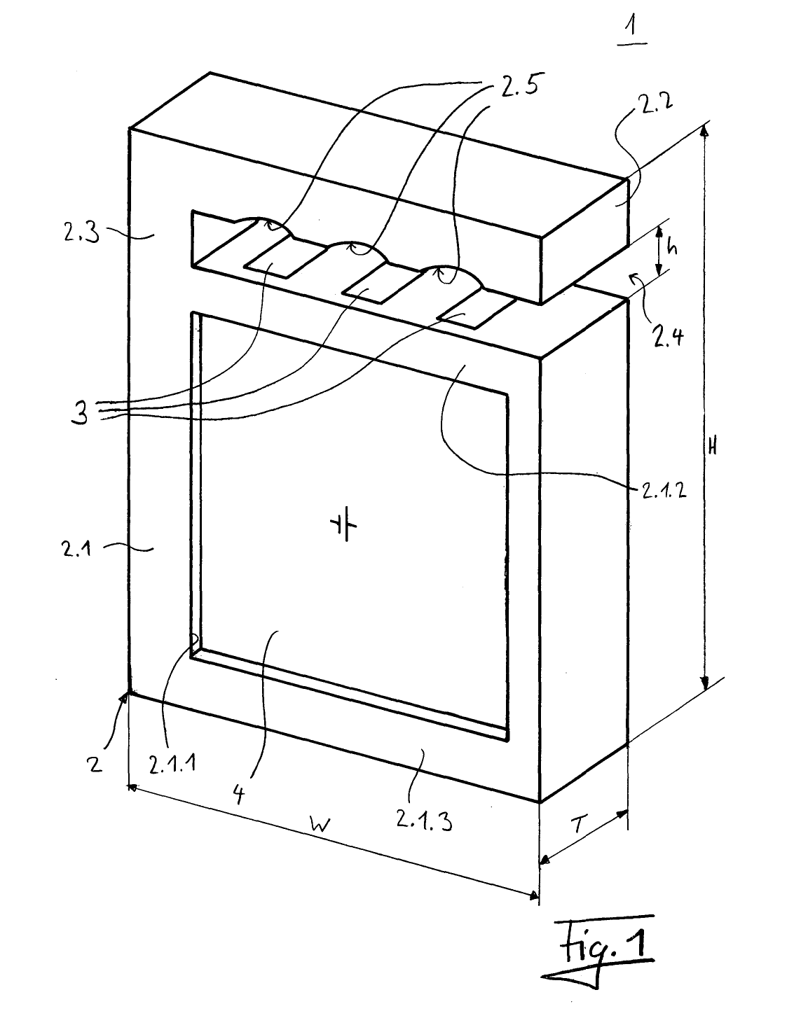

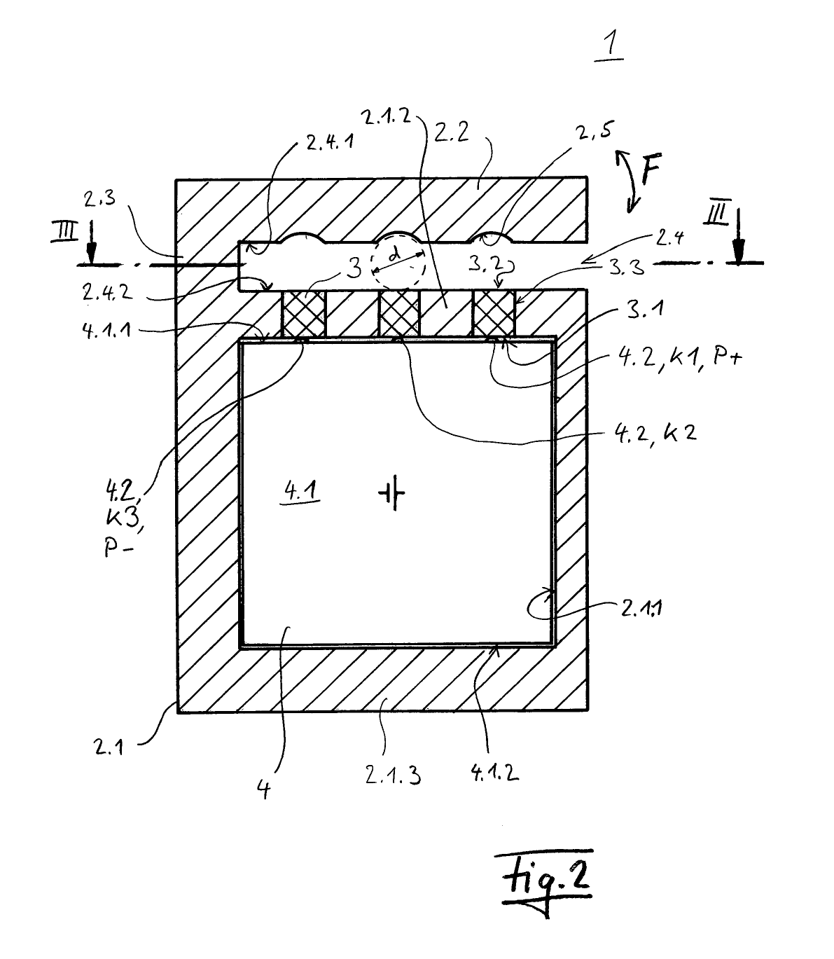

Drawing on FIGS. 1 to 3, a single battery 1 with a frame 2 is described below as a preferred embodiment of the invention. FIG. 1 is thereby a schematic spatial view of a single battery 1, FIG. 2 is a schematic cross-sectional view of the single battery 1 in a plane defined by a height direction H and a width direction W of the single battery 1, and FIG. 3 is a schematic sectional view of the single battery 1 along dashed/dotted line III-III from FIG. 2 in the viewing direction of the associated arrows.

In accordance with the FIG. 1 representation, a single battery 1 has a frame 2 with three embedded contact elements 3 and a battery cell 4 accommodated in the frame 2.

The frame 2 exhibits a flat rectangular (plate-shaped) basic form with a height H, a width W and a thickness T which is sectioned into a main body 2.1, an arm 2.2 and a connecting section 2.3 which connects the arm 2.2 to the main body 2.1. A gap 2.4 is formed between the arm 2.2 and the main body 2.1, its upper face 2.4.1 limiting the arm 2.2 in the downward direction and its lower face 2.4.2 limiting the main body 2.1 in the upward direction. The gap 2.4 exhibits a gap height h.

The main body 2.1 has a window-like cutout 2.1.1, rectangular in cross-section, for accommodating the battery cell 4. The contact elements 3 are embedded into an upper cross bar 2.1.2 of the main body 2.1 which extends between the lower face 2.4.2 of the gap 2.4 and an upper boundary surface of the cutout 2.2.1.

The contact elements 3 are made from copper and are formed as at least substantially rectangular conductor elements cast into the frame 2. The contact elements 3 comprise a lower contact surface 3.1 aligned with the upper boundary surface of the cutout 2.1.1 of the main body 2.1 and an upper contact surface 3.2 aligned with the lower surface 2.4.2 of the gap 2.4. Flanks 3.3 mated to the material of the frame 2 extend between the upper contact surface 3.2 and the lower contact surface 3.1 of the contact elements 3.

The battery cell 4 comprises a cell body 4.1 and three contact nipples 4.2.

The cell body 4.1 contains a not-shown electrode array which forms a battery cell or accumulator cell (single cell) respectively. Electrode films of different polarity, particularly aluminum and/or copper films and/or metal alloy films coated with electrochemically active materials containing at least lithium or a lithium compound, are stacked in typical fashion one above the other in the electrode array as such and electrically insulated from one another by means of a (not shown) separator, particularly a separator film. Electrode films and separators thus form a galvanic arrangement, particularly a lithium ion secondary cell, which is capable of being used to absorb electrical energy, electrochemically convert same for storage, electrochemically reconvert and release electrical energy. Peripheral areas of the electrode films of like polarity are electrically connected together, for example—albeit not mandatory—pressed or welded together in electrically conductive fashion, and form the terminal contacts of the electrode array. The electrode array is sealed into a not further detailed housing which is gas/fluid-tight in order to form the cell body 4.1.

Three spherical contact nipples 4.2 extend from an upper side (upper narrow side) 4.1.1 of the cell body 4.1. The contact nipples form cell contacts K1, K2, K3; they extend through the housing of the cell body 4.1 and are connected in the interior of same to contact areas of the electrode array. In detail, the contact nipple 4.2 forming a first cell contact K1 is connected to a positive terminal contact of the electrode array and forms a positive cell terminal P+ of the cell 4. The contact nipple 4.2 forming a second cell contact K2 is furthermore connected to a measuring contact within the cell 4 and forms a measuring connection of the cell 4. Lastly, the contact nipple 4.2 forming a third cell contact K3 is connected to a negative terminal contact of the electrode array and forms a negative cell terminal P− of the cell 4.

The battery cell 4 and the frame 2, in particular the cutout 2.1.1 of cutout 2.1, are so dimensioned relative each other that during the use of the battery cell 4 in the frame 2, the contact nipples 4.2 press against the lower contact surfaces 3.1 of contact elements 3. A lower narrow side 4.1.2 of the cell body 4.1 is thereby supported on a lower cross bar 2.1.3 of the main body 2.1 of the frame 2.

Three grooves 2.5 are formed in the surface of the arm 2.2 facing the gap 2.4 (i.e. the upper face 2.4.1 of gap 2.4) which extend in parallel in the thickness direction of the frame 2 over the entire thickness T of said frame 2. The grooves 2.5 exhibit a circular cross section and are situated opposite the contact elements 3. The circular form having a diameter d is indicated by the dotted line within the middle groove 2.5; the diameter corresponds to the greatest distance of the groove 2.5 (the base of the groove) from the lower face 2.4.2 of the gap 2.4 or from the upper contact surface 3.2 of the opposite contact element 3 respectively. The arm 2.2 is furthermore pivotable in a spring direction F, whereby the connecting section 2.3 acts a resilient swivel joint. The function of this arrangement will become evident in connection with the description of a battery assembly based on FIG. 4.

FIG. 4 is a schematic spatial view illustrating a battery assembly 5 as a further embodiment of the present invention.

The battery assembly 5 comprises a plurality of single batteries 1 in accordance with FIGS. 1 to 3 and three conductor rails 6.

The single batteries 1 are arranged successively in a stacking direction s. In accordance with the FIG. 4 depiction, one single battery 1 has been taken out of the assemblage, thereby leaving a gap in assembly 5.

The three conductor rails 6 extend parallel to one another in the stacking direction s. Their diameter d corresponds to the circular section diameter d of the grooves 2.5 depicted in FIG. 2 with oversize; the spacing of the conductor rails 6 corresponds to the spacing of the grooves 2.5 in the width direction W of the single batteries 1. The conductor rails 6 serve in this embodiment as a positive busbar S+, a negative busbar S− and a signal transmission line or signal busbar S0 respectively.

In accordance with the FIG. 4 depiction, the single batteries 1 are threaded onto the conductor rails 6 through the gap 2.4 and the conductor rails 6 rest in the grooves 2.5. The flexible pivotability of the arm 2.2 relative to the main body 2.1 of the frame 2 (spring direction F in FIG. 2) reliably presses the conductor rails 6 against the contact elements 3 and ensures an electrical contact. Individual single batteries 1 are disengageable and removable from the assemblage in mounting direction M, wherein only the spring load of the connecting section 2.3 is to be overcome as resistance.

In this way, an electrical contact of the positive busbar S+ to the contact nipples 4.2 of the battery cell 4 forming a positive cell terminal P+, of the negative busbar S− to the contact nipples 4.2 of the battery cell 4 forming a negative cell terminal P−, and of the signal busbar S0 to the middle contact nipples 4.2. of the battery cell 4 is created in the aggregate battery assembly 5.

The battery assembly 5 thus forms in particularly a parallel connection of the single batteries 1. Hence a plurality of single batteries having predefined individual voltages (battery voltage) can be readily connected into a battery assembly of desired capacity.

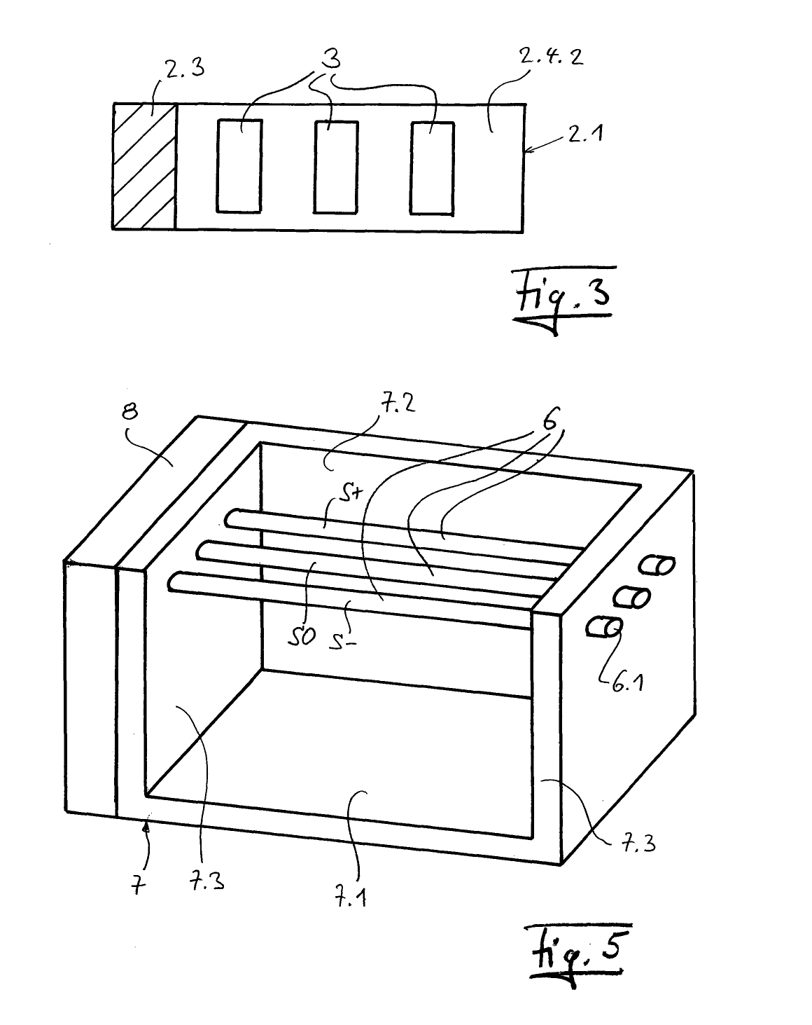

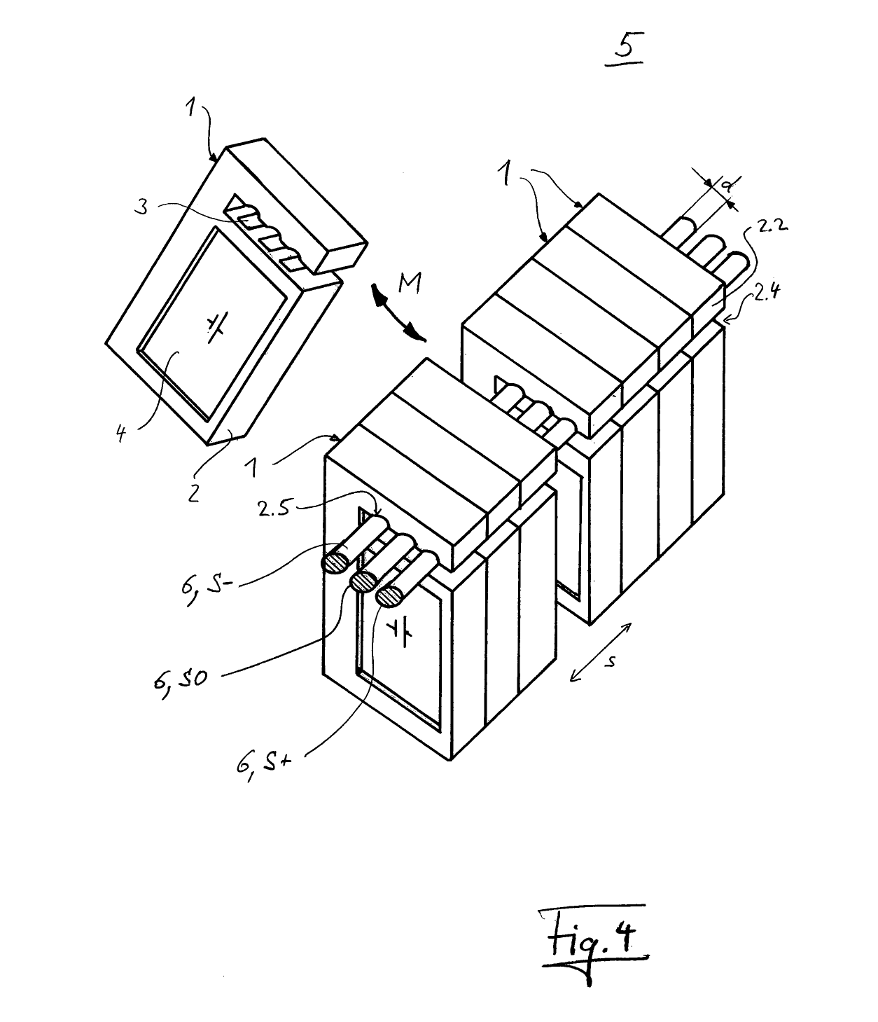

FIG. 5 illustrates a battery case 7 having conductor rails 6 and a controller 8 in a schematic spatial view.

In accordance with the FIG. 5 depiction, a battery case 7 is configured as an open rectangle having a bottom wall 7.1, a rear wall 7.2 and two side walls 7.3. The battery case 7 is thus open at the top and at the front.

A controller 8 is affixed to the exterior of a side wall 7.3. Three conductor rails 6 extend between and through the side walls 7.3. The free ends 6.1 project from the side walls 7.3 to the exterior of the battery case 7 and terminate on one side in the controller 8.

The conductor rails 6 in FIG. 5 correspond to the conductor rails 6 in FIG. 4. Thus a plurality of single batteries 1 pursuant FIGS. 1 to 3 can be hooked onto the conductor rails 6 in the battery case 7—between the side walls 7.3—so as to form a battery assembly as in the battery assembly 5 of FIG. 4. The battery assembly 5 in the battery case 7 can also be termed a battery assemblage. Single batteries 1 are individually replaceable without taking apart the entire battery assemblage in the battery case 7; hence, under certain circumstances, replacement is also possible during operation.

The controller 8 is designed and disposed so as to recognize and process the status conditions of a battery assemblage connected to the conductor rails 6. For example, but not exclusively, the controller 8 recognizes a voltage state and a capacitance of the battery assemblage as well as of the single batteries 1 in the battery assemblage. Measurement data and control data can be exchanged between the controller 8 and the single batteries 1 via signal busbar S0. The signal busbar S0 can thereby function for example, but not exclusively, as a serial bus. Terminal contacts (not shown) to be used as the terminals for the aggregate battery assembly are provided on one side of the controller 8.

A plurality of battery cases 7 can be coupled together via the free ends 6.1 of the conductor rails 6 using means not depicted in any greater detail. Each battery case 7 can thereby be allocated a controller 8 or one single controller 8 can serve all the connected battery cases 7 or the battery assemblages arranged therein respectively.

The following will set forth a number of preferential modifications of the invention.

Although the present invention was described above with reference to concrete embodiments of its substantial features, it should go without saying that the invention is not limited to these embodiments but rather can be modified and expanded within the extent and scope defined in the claims, for example—but not restrictively—as put forth below.

Although the contact elements 3 are cast into the frame 2 in the embodiment, they can also be cemented, shrink-wrapped or the like into the frame 2. Also, the contact elements 3, described as rectangles with parallel flanks, can also exhibit conical flanks 3.3, running for instance from the lower contact surface 3.1 to the upper contact surface 3.2, so as to prevent the contact elements 3 from unintentionally migrating into the gap 2.4. In the case of casting, other form-locking means can also be provided to prevent an unintentional migrating of the contact elements 3. In a further modification, the contact elements 3 can exhibit a completely different basic form, for instance a cylindrical or frustoconical form having a circular or oval cross section.

Apart from copper, the contact elements 3 can be made from any good electrically conductive material such as for instance aluminum, iron or the like or an alloy of one or more of the same, including copper, or from a conductive plastic or a conductive ceramic. To lessen surface resistance, contact surfaces 3.1, 3.2 of the conductor elements 3 can be coated with a contact mediator substance such as for instance gold, silver or the like or an alloy of one or more of the same.

The lower contact surfaces 3.1 of the contact elements 3 can comprise recesses into which the contact nipples 4.2 of the battery cells 4 engage so as to hinder the battery cell 4 from unintentionally falling out of the frame 2.

The upper contact surfaces 3.2 of the contact elements 3 can comprise grooves corresponding to the grooves 2.5 in the upper face 2.4.1 of groove 2.4, whereby the grooves of the contact elements 3 continue in the lower face 2.4.2 of groove 2.4 so as to realize a two-point engagement of the conductor rails 6.

The cutout 2.1.1 in the main body 2.1 of frame 2 was described as a window-like opening. In one modification, the cutout 2.1.1 can also be closed on one flat side of the main body 2.1 of the frame 2. The flat sides (in the presently described modification: can be the open flat side) of the main body 2.1 of the frame 2 can moreover be closeable by means of a cover.

Resilience to the connecting section 2.3 of the frame 2 can be increased by means of notching, hollowing or selecting softer materials for specific zones. Alternatively, resilience can be lessened by selecting harder materials for specific zones should this be necessary. Such zonal variability to the material properties is comparatively easy to realize in the case of plastic components.

The rigidity to the arm 2.2 of the frame 2 can likewise be increased by means of material selection, by fiber reinforcement or by reinforcing for instance with a metal profile.

Although the battery cell 4 is described in the embodiment as a single cell, the battery cell 4 can also comprise a plurality of individual cells internally connected in parallel and/or series to obtain a desired battery cell 4 terminal voltage and capacity. In a further modification, a plurality of battery cells 4 can be accommodated in the frame 2. The multiple battery cells 4 can thereby, albeit not imperatively, be interconnected by an additional component provided between the plurality of battery cells 4 and the upper cross bar 2.1.2. As an example, albeit not restrictively, cell terminals of the multiple battery cells 4 can be connected in a series connection by the additional component and the free ends of the series connection can be connected to the respective contact elements 3. The plurality of battery cells 4 can thereby, albeit not imperatively, be arranged with alternating terminal positions, whereby also the structure, particularly internal wiring, of the additional component can be simplified.

The battery cells 4 in the embodiment can be accommodated in the frame 2 and removable from the frame 2. In one modification, the frame 2 itself forms a housing for an electrode array and the single battery 1 can thus be configured as a battery cell (single cell or multi-cell) and free ends of the electrode films (conductor tabs) can be directly connected to the contact elements 3.

In a further modification, contact elements are arranged in the area of the grooves 2.5 in the arm 2.2, whereby the poll contacts of the electrode array of the battery cell 4 or an electrode array integrated in the main body 2.1 of the frame 1 are connected to the contact elements by means of a line connection, in particular routed through the connecting section 2.3. In a further development of this embodiment, the gap height h is at least as great as the conductor rail diameter d and elastic pressure elements are provided in the lower face 2.4.2 of the gap 2.4, opposite the grooves 2.5, which give way upon the conductor rails 6 being introduced into the face 2.4.2 and then, once the conductor rails 6 engage into the grooves 2.5, press against the conductor rails 6 from below; this further development can dispense with an elastically pivotable design to the arm 2.2. In this modification, the force of gravity alone can hinder the conductor rails 6 from unintentionally raising off the contact elements.

It is understood that the number of conductor rails 6 can differ from the number depicted. For example, two conductor rails suffice as a positive and negative conductor rail to tap the battery voltage of the single batteries 1. On the other hand, albeit not solely, additional conductor rails can or could be provided to tap different intermediate voltages of the single batteries 1 or to fulfill further signal transmission functions.

Conductor rails 6—particularly, albeit not solely, signal rail S0—can be of multicore design and contact elements 3 can be of multipolar design. Particularly, albeit not restrictively, a contact element 3 can comprise a plurality of contact zones extending parallel to one another in stacking direction s, or thickness direction T respectively, and insulated relative one another which correlate to corresponding contact zones of a conductor rail 6 when the respective conductor rail 6 is non-rotatably positioned in the battery case 7 so as to ensure an explicit positioning. Contact elements 3 can further be provided both on the upper face 2.4.1 as well as on the lower face 2.4.2 and an associated conductor rail can comprise separate conductive areas in the upper and lower region; non-rotatable mounting is also necessary in this case.

The single batteries 1 can comprise a gripping device to grip the single battery 1. The single batteries 1 can also comprise a deactivating device to disconnect line connections within the single battery 1 in order to prevent unwanted electrical contacts upon removal. Such a deactivating device can be operatively coupled to a gripping device. A locking device can also be provided which locks the arm 2.2 to the main body 2.1 upon manual intervention or automatically when the gripping device disengages.

The battery assembly 5 is an energy storage arrangement in the sense of the invention. Each single battery 1 is a partial energy store as well as an energy storage apparatus in the sense of the invention. The conductor rails 6 form a contacting device in the sense of the invention. The frame 2 is a frame structure in the sense of the invention. Each battery cell 4 or an electrode array integrated into the frame 2 is an energy storage section in the sense of the invention. The contact nipples 4.2 are connecting ends in the sense of the invention. When the single batteries 1 are configured as integrated battery cells or multicells, conductor tabs or other terminal contacts of an electrode assembly can be considered connecting ends in the sense of the invention. Upper contact surfaces 3.2 of the contact elements 3 form a contact section in the sense of the invention. The arm 2.2 is a pressure section in the sense of the invention. Mentioned but not shown in greater detail pressure elements can also be a pressure section in the sense of the invention. The connecting section 2.3 is a spring section in the sense of the invention. The gap 2.4 is a receiving section in the sense of the invention. Grooves 2.5 are engaging sections in the sense of the invention.

### LIST OF REFERENCE NUMERALS

1 single battery
2 frame
2.1 main body
2.1.1 cutout
2.1.2 upper cross bar
2.1.3 lower cross bar
2.2 arm
2.3 connecting section
2.4 gap
2.4.1 upper face
2.4.2 lower face
2.5 groove
3 contact element
3.1 lower contact surface
3.2 upper contact surface
3.3 flank
4 battery cell
4.1 cell body
4.2 contact nipple
5 battery assembly
6 conductor rail
6.1 free end
7 battery case
8 controller
d diameter
h gap height
s stacking direction
F spring direction
H height
K1, K2, K3 cell contact
M direction of installation (mounting direction)
P+ positive cell terminal
P− negative cell terminal
S+ positive busbar
S− negative busbar
S0 signal busbar
T thickness
W width

It is explicitly noted that the above list of reference numerals is an integral part of the description.

1-10. (canceled)

11. An energy storage arrangement comprising:
a plurality of partial energy storages; and
a contacting device configured to interconnect the plurality of partial energy storages, wherein
each partial energy storage comprises a frame structure which supports an energy storage section having an electrode array and at least two connecting ends,
the partial energy storage comprises a pressure section and a contact section,
the connecting ends of the energy storage section are connected to the contact section, and
the pressure section is configured and arranged so as to elastically push the contacting device against the contact section.

12. The energy storage arrangement according to claim 11, wherein the contacting device comprises at least two conductor rails.

13. The energy storage arrangement according to claim 11, wherein the pressure section of the partial energy storages is elastically movable by a spring section of the frame structure.

14. The energy storage arrangement according to claim 11, wherein the frame structure comprises a receiving section for receiving a section of the contacting device allocated to one of the partial energy storages.

15. The energy storage arrangement according to claim 14, wherein the receiving section is open on one side.

16. The energy storage arrangement according to claim 14, wherein the receiving section comprises at least one engaging section to engage the contacting device.

17. An energy storage apparatus for configuration as a partial energy storage in an energy storage arrangement according to claim 11, comprising:
a frame structure configured to support an energy storage section comprising an electrode array and at least two connecting ends, wherein
the frame structure comprises a receiving section to receive at least one section of a contacting device for interconnecting a plurality of energy storage apparatus together,
the energy storage apparatus comprises a pressure section and a contact section,
the connecting ends of the energy storage section are connected to the contact section, and
the pressure section is designed and arranged to elastically push the contacting device against the contact section.

18. The energy storage apparatus according to claim 17, wherein the energy storage section is integrated into the frame structure.

19. The energy storage apparatus according to claim 17, wherein the energy storage section is detachably connected to and engageable with the frame structure.

20. A method of operating an energy storage arrangement in accordance with claim 11, comprising:
supplying a load from the energy storage arrangement with electrical energy;
removing a partial energy storage from the energy storage arrangement, wherein the load is supplied by the energy storage arrangement; and
inserting a partial energy storage into the energy storage arrangement, wherein the load is supplied by the energy storage arrangement.
